(19) United States
(12) Patent Application Publication
(10) Pub. No.: US 2004/0163090 A1
(43) Pub. Date: Aug. 19, 2004

(54) Method, system, and article of manufacture for a command line interface

(75) Inventors: Pascal Ledru, Boulder, CO (US); Xuefeng Yao, Boulder, CO (US)

Correspondence Address: LAHIVE & COCKFIELD, LLP., 28 STATE STREET, BOSTON, MA, 02109, US

(73) Assignee: Sun Microsystems, Inc,

(21) Appl. No.: 10/371,367

(22) Filed: Feb. 19, 2003

(51) Int. Cl. G06F 3/00

(52) U.S. Cl. 719/320

(57) ABSTRACT

Provided are a method, system, and article of manufacture for interfacing with a command line interface. A page of a first type is determined corresponding to a request received from a command line interface client. The page of the first type is filtered into a page of a second type. The page of the second type is sent to the command line interface client.

### BACKGROUND OF THE INVENTION

1. Field of the Invention

The present invention relates to a method, system, and an article of manufacture for a command line interface.

2. Description of the Related Art

A computer program may display data to a user through a user interface. The user interface may include a graphical user interface (GUI), a Web browser, a text based command line interface (CLI), etc. Prior art computer programs that display data through a command line interface include utilities in the UNIX* operating system such as “ls”, “cd”, “pwd,” etc. A script is a sequence of command line utilities that are typically stored in one or more files. A script may be used to automatically execute several functions in one program. *UNIX is a trademark of “The Open Group”; Internet Explorer, MSDOS are trademarks of Microsoft Corporation; Netscape, Javascript are trademarks of Netscape Communications Corporation; Java is a trademark of Sun Microsystems, Inc.

Many client applications currently use a Web browser to interface with a server system. The Web browser connects to a Web server using a Web enabled protocol, such as, the hypertext transfer protocol (HTTP), the secure hypertext transfer protocol (HTTPS), etc. The Web browser requests a page from the Web server. In response to the request from the Web browser for the page, the Web server may retrieve a static page, such as a Hypertext Markup Language (HTML) page, an extensible markup language (XML) page, etc., for returning to the Web browser. If the Web server is written in the Java* programming language, then the Web server may retrieve a dynamic page, such as, a servlet or a Java server page (JSP), and return the page to the Web browser. *UNIX is a trademark of “The Open Group”; Internet Explorer, MSDOS are trademarks of Microsoft Corporation; Netscape, Javascript are trademarks of Netscape Communications Corporation; Java is a trademark of Sun Microsystems, Inc.

### SUMMARY

Provided are a method, system, and article of manufacture for interfacing with a command line interface. A page of a first type is determined corresponding to a request received from a command line interface client. The page of the first type is filtered into a page of a second type. The page of the second type is sent to the command line interface client.

Provided further are a method, system, and article of manufacture for interfacing with a client. A request is received for a page from the client. A determination is made if the request was received from a browser or a command line interface. If the request was received from the command line interface, a response corresponding to the requested page is sent to the command line interface.

Provided additionally are a method, system, and article of manufacture, wherein a first request is sent from a command line interface program at a client. A second request is sent from a browser at the client, wherein the first and second requests are for a page. A response is received in response to the first request, wherein the response excludes all graphical elements in the page. The page is received in response to the second request.

The implementations allow Web pages from a server to be rendered intelligibly to both a Web browser and a command line interface.

### BRIEF DESCRIPTION OF THE DRAWINGS

Referring now to the drawings in which like reference numbers represent corresponding parts throughout:

FIG. 1 illustrates a block diagram of a computing environment, in accordance with certain described aspects of the invention;

FIG. 2 illustrates a block diagram of a Java server page, in accordance with certain described implementations of the invention;

FIG. 3 illustrates a display on a Web browser, in accordance with certain described implementations of the invention;

FIG. 4 illustrates a block diagram of a filter and associated data structures, in accordance with certain described implementations of the invention;

FIG. 5 illustrates a block diagram of a display on a command line interface, in accordance with certain described implementations of the invention;

FIG. 6 illustrates a block diagram of a command line interface controller, in accordance with certain described implementations of the invention;

FIG. 7 illustrates a block diagram of a mapping data structure, in accordance with certain described implementations of the invention;

FIG. 8 illustrates a block diagram for a deployment descriptor file, in accordance with certain described implementations of the invention;

FIG. 9 illustrates via a block diagram the logic for transmitting data to a command line interface client, in accordance with certain described implementations of the invention;

FIG. 10 illustrates logic for sending data to a command line interface client, in accordance with certain described implementations of the invention; and

FIG. 11 illustrates a block diagram of a computer architecture in which certain described aspects of the invention are implemented.

### DETAILED DESCRIPTION

In the following description, reference is made to the accompanying drawings which form a part hereof and which illustrate several implementations. It is understood that other implementations may be utilized and structural and operational changes may be made without departing from the scope of the present implementations.

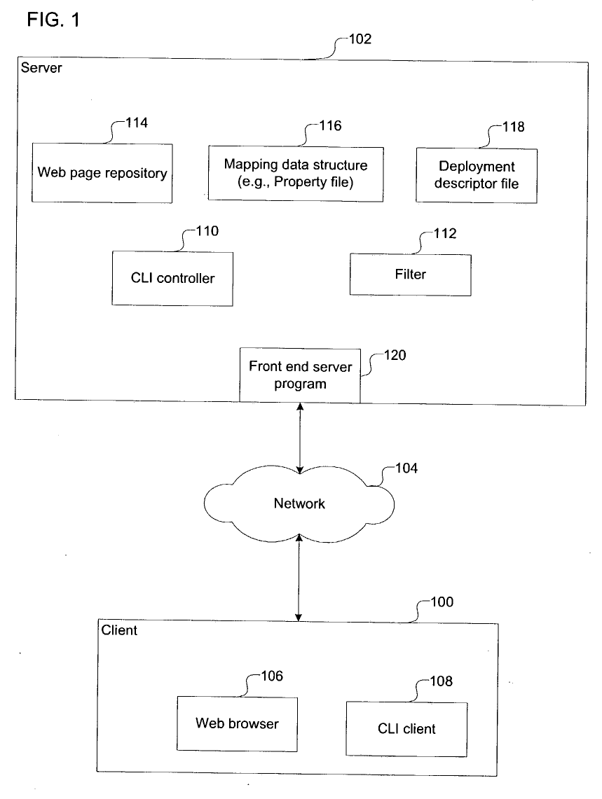

FIG. 1 illustrates a block diagram of a computing environment, in accordance with certain implementations of the invention. A client 100 and a server 102 are connected to a network 104. The client 100 and the server 102 may comprise any computational device known in the art, such as a personal computer, a workstation, a server, a mainframe, a hand held computer, a palm top computer, a telephony device, a network appliance, etc. The network 104 may comprise any network known in the art, such as the Internet, an intranet, a Local area network (LAN), a Storage area network (SAN), a Wide area network (WAN), a wireless network, etc. The client 100 may alternatively connect to the server 102 without a network, such as through direct lines, common bus systems, etc., in a manner known in the art. Also the network 104 may be part of one or more larger networks or may be an independent network or may be comprised of multiple interconnected networks. While in the described implementations, the client 100 and the server 102 communicate within a client-server paradigm, with the client 100 acting as a client and the server 102 acting as a server, the client 100 and the server 102 may also communicate within a peer-to-peer or any other paradigm known in the art. Furthermore, in alternative implementations, additional clients may communicate with the server 102.

The client 100 comprises a Web browser 106 and a command line interface (CLI) client 108. The Web browser 106 is any Web browser known in the art, such as, the Internet Explorer* browser, the Netscape* browser, etc. The command line interface client 108 is an application that displays a command line interface on the client 100. The displayed command line interface may comprise a user interface program executing in the client 100 in which a user responds to a visual prompt by typing in a command on a specified line, receives a response, and then enters another command, and so forth. The command line interface client 108 may be any command line interface client known in the art, such as the Korn shell or the Bourne shell for the UNIX operating system, the MS-DOS* Prompt application for the Windows operating system, etc. The Web browser 106 and the command line interface client 108 may comprise an integrated management application to access information from the server 102. *UNIX is a trademark of “The Open Group”; Internet Explorer, MSDOS are trademarks of Microsoft Corporation; Netscape, Javascript are trademarks of Netscape Communications Corporation; Java is a trademark of Sun Microsystems, Inc.

The server 102 includes a CLI controller 110, a filter 112, a Web page repository 114, a mapping data structure 116, a deployment descriptor file 118, and a front end server program 120.

The CLI controller 110 comprises a controller program for translating command line interface requests from the command line interface client 108. The CLI controller 110 may receive requests generated by the command line interface client 108. The CLI controller 110 may interpret a received request to determine a corresponding Web page to facilitate the extraction of information for the command line interface client 108. The CLI controller 110 may comprise a standalone application or be part of one or more other applications.

The filter 112 comprises a filter application for transcoding pages, including Web pages, from a graphical format to a plain text format. Transcoding is a process by which data is changed from one format to another. The filter 112 may apply any transcoding process known in the art to transcode Web pages into a plain text or any other format. During the transcoding the filter 112 may remove all graphical user interface elements, such as images, icons, etc., from the Web page and may potentially rearrange the textual data in a format suitable for display on the command line interface client 108.

The server 102 includes a Web page repository 114. In certain implementations, the Web page repository 114 may include a collection of pages, such as, Java server pages. The Java server pages are dynamic and may query a database, etc., in a manner known in the art. The Java server pages generate an output similar to a static HTML page. In alternative implementations, the Web pages repository 114 may also include other type of Web pages known in the art, such as, Javascript*, Active server pages, HTML etc. *UNIX is a trademark of “The Open Group”; Internet Explorer, MSDOS are trademarks of Microsoft Corporation; Netscape, Javascript are trademarks of Netscape Communications Corporation; Java is a trademark of Sun Microsystems, Inc.

The mapping data structure 116 maps parameters included in requests from the command line interface client 108 to Web pages that are stored in the Web page repository 114. The mapping data structure 116 can be implemented in any data structure or file format known in the art, such as, a property file in the Java programming language, a table, etc.

The deployment descriptor file 118 indicates a mapping between a filter and a CLI controller. The deployment descriptor file 118 may include the conditions in which the filter 112 should be applied by the CLI controller 110.

The front end server program 120 receives requests received at the server 102 via the network 104. The front end server program 120 may comprise a Web server program known in the art. The front end server program 120 is capable of parsing requests received in a variety of protocols including HTTP and HTTPS.

The client 100 may send requests to the server 102 either via the Web browser 106 or the command line interface client 108. The server 102 returns Web pages to the client 100 if the request is from the browser 106. If the request is form the command line interface client 108, the server 102 may return a plain text page to the client 100. Equivalent requests may be made from both the Web browser 106 and the command line interface client 108 to the server 102. The server 102 automatically tailors the response for the Web browser 106 or the command line interface client 108 as the case may be.

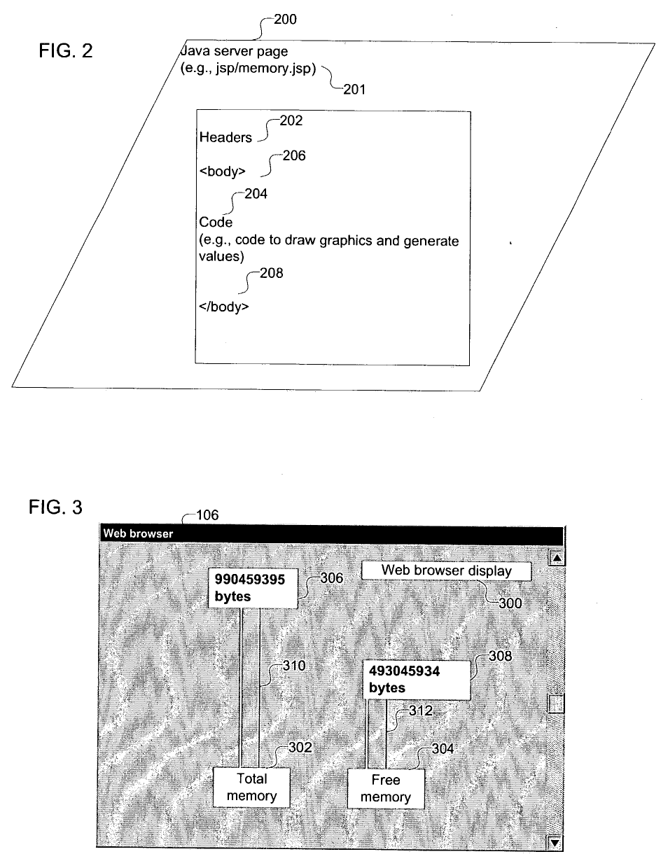

FIG. 2 illustrates a block diagram of a Java server page 200 that may be generated by the Web page repository 114, in accordance with certain implementations of the invention. The Java server page 200 may comprise a file 201 with a name, such as, “memory.jsp”, located in the directory “jsp”. The Java server page 200 may include headers 202 and code 204 to draw graphics and generate values 204 included within the body 206, 208 of the Java server page 200. While only one Java server page 200 is shown in FIG. 2 a plurality of Java server pages may be stored in the Web page repository 114.

While FIG. 2 shows a Java server page 200, other type of Web pages may also include equivalent information. For example, XML, HTML or Active server pages may include instructions that cause graphics and values to be displayed by any Web browser, such as, the Web browser 106.

FIG. 3 illustrates a Web browser display 300 on the client Web browser 106, in accordance with certain described implementations of the invention. The Web browser display 300 shows the total memory 302 and the free memory 304 of a computer system in the form of a bar chart. The total memory 302 is shown as 990459395 bytes (reference numeral 306) and the free memory 304 is shown as 493045934 bytes (reference numeral 308). Vertical bars 310 and 312 graphically illustrate the total memory 302 and the free memory 304 respectively.

The Web browser display 300 may be generated on the client Web browser 106 by interpreting the Java server page 200. The Web browser display 300 includes textual elements, such as, total memory 302, free memory 304, 990459395 bytes (reference numeral 306), 493045934 bytes (reference numeral 308). The graphical elements include the bars 310, 312. While the Web browser 106 can display the graphical elements 310, 312 the command line interface client 108 may not display the graphical elements 310, 312 directly.

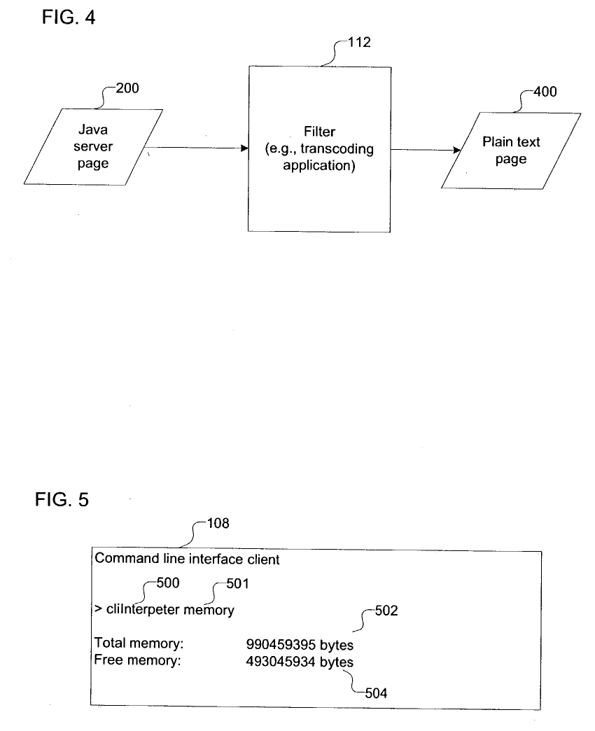

FIG. 4 illustrates a block diagram of the filter 112 and associated data structures, in accordance with certain implementations of the invention. The filter 112 is an application program, such as, a transcoding application, that can take as an input any HTML page that may have been generated by the Java server page 200 and generate a plain text page 400. The plain text page 400 does not include any graphical elements, such as graphical elements 310, 312 and contain only textual elements such as, textual elements total memory 302, free memory 304, 990459395 bytes (reference numeral 306), 493045934 bytes (reference numeral 308).

While FIG. 4 shows the filter 112 transcoding the HTML page corresponding to a Java server page 200 into a plain text page 400, different filters may be constructed to transcode different types of Web pages. For example, a particular filter may transcode HTML pages, another filter may transcode active server pages, etc. Additionally, a particular filter may transcode an HTML page to a plain text page generated in an XML format for a specialized command line interface that is capable of interpreting XML pages.

FIG. 5 illustrates a block diagram of a display on the command line interface client 108, in accordance with certain implementations of the invention. A user enters “cliInterpreter memory” in the command line interface client 108, where “cliInterpreter” 500 is a command to the command line interface client 108 and “memory” 501 is the request parameter. In response, the command line interface client 108 displays “Total Memory: 990459395 bytes” (reference numeral 502) and “Free memory: 493045934 bytes” (reference numeral 504), which are plain text data received from the server 102, where the plain text data correspond to the textual elements included in the Web browser display 300 displayed on the Web browser 106. The graphical elements 310, 312 that were displayed on the Web browser display 300 are not displayed on the command line interface 108.

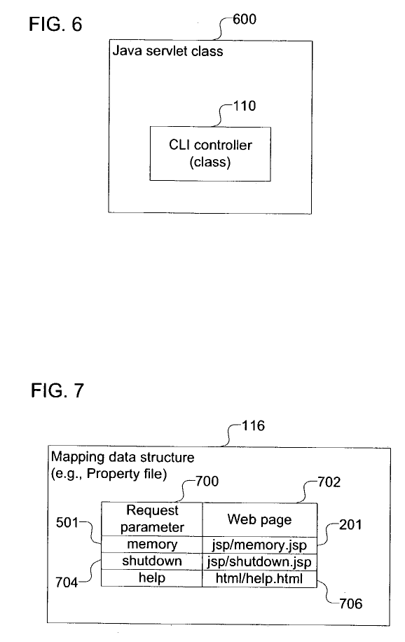

FIG. 6 illustrates a block diagram of the CLI controller 110, in accordance with certain implementations of the invention. The CLI controller 110 is shown as a class that derives from the Java servlet class 600 in the Java programming language. The Java servlet class provides Web developers with a simple, consistent mechanism for extending the functionality of any Web server, such as server 102. Thus the CLI controller 110 is a servlet, i.e., a server program that derives from the Java servlet class 600 and runs on the server side of a client-server system.

In alternative implementations, the CLI controller 110 may derive from other classes or may be written in a non object-oriented language as a standalone application or as part of other applications. The CLI controller 110 servlet receives requests from the command line interface client 108 and interprets the requests to extract information to output to the command line interface client 108. The CLI controller 110 servlet may comprise a single servlet or may comprise of a plurality of servlets.

FIG. 7 illustrates a block diagram of the mapping data structure 116, in accordance with certain described implementations of the invention. The mapping data structure 116 may be implemented as a property file in the Java programming language in a manner known in the art. The mapping data structure contains mappings between request parameters 700 and web pages 702. The request parameters 700, such as “memory” 501, are entered by a user at the command line interface client 108. The Web pages 702 are maintained by the Web page repository 114. For example, corresponding to the request parameter “memory” 501 there may be a Web page “jsp/memory.jsp” 201. Similarly corresponding to a request parameter “shutdown” 704 there may be a Web page “jsp/shutdown.jsp” 706.

The mapping data structure 116 provides information mapping requests from the client 100 to Web pages maintained by the Web page repository 114.

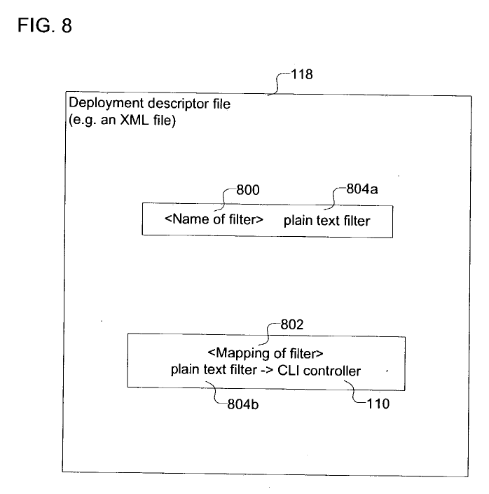

FIG. 8 illustrates a block diagram for the deployment descriptor file 118, in accordance with certain described implementations of the invention. The deployment descriptor file 118 indicates that the filter 112 may be applied when a request is handled by the CLI controller 110. If a plurality of filters reside on the server 102, alternative implementations of the deployment descriptor file 118 may indicate a different filter to apply when a request is handled by the CLI controller 110.

In certain implementations the deployment descriptor file 118 may comprise an extensible markup language (XML) file. A representative element <Name of filter> 800 may be indicated as a “plain text filter” 804a. Another representative element <Mapping of filter> 802 maps the CLI controller 110 to the plain text filter 804b (plain text filter 804a and 804b are the same and in certain implementations may be the same as the filter 112).

Therefore the deployment descriptor file 118 indicates that if a request from the client 100 has been made to the CLI controller 110 then the plain text filter 804a, 804b should be applied to the response before sending the response to the client 100. Although the described implementations show the deployment descriptor file 118 when there is a single CLI controller 110, many variations are possible in alternative implementations where there are a plurality of filters and CLI controllers.

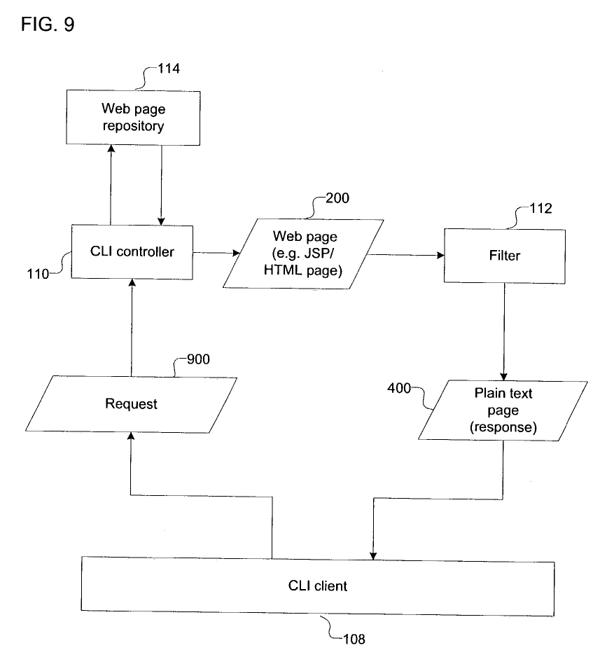

FIG. 9 illustrates the logic for transmitting data to the command line interface client 108, in accordance with certain implementations of the invention. The command line interface client 108 sends a request 900 to the CLI controller 110. The CLI controller 110 retrieves the Web page 200 corresponding to the request 900 from the Web page repository 114. The CLI controller 110 sends the Web page 200 to the filter 112. The filter 112 transcodes the Web page 200 to a plain text page 400. The filter 112 sends the plain text page 400 as a response to the request 900 from the command line interface client 108.

Therefore, the command line interface client 108 sends a request 900 to the server 102 and receives a plain text page 400 as a response. If the Web browser 106 makes an equivalent request the server 102 then the server may return the Web page 200, where the Web page 200 may contain graphical elements.

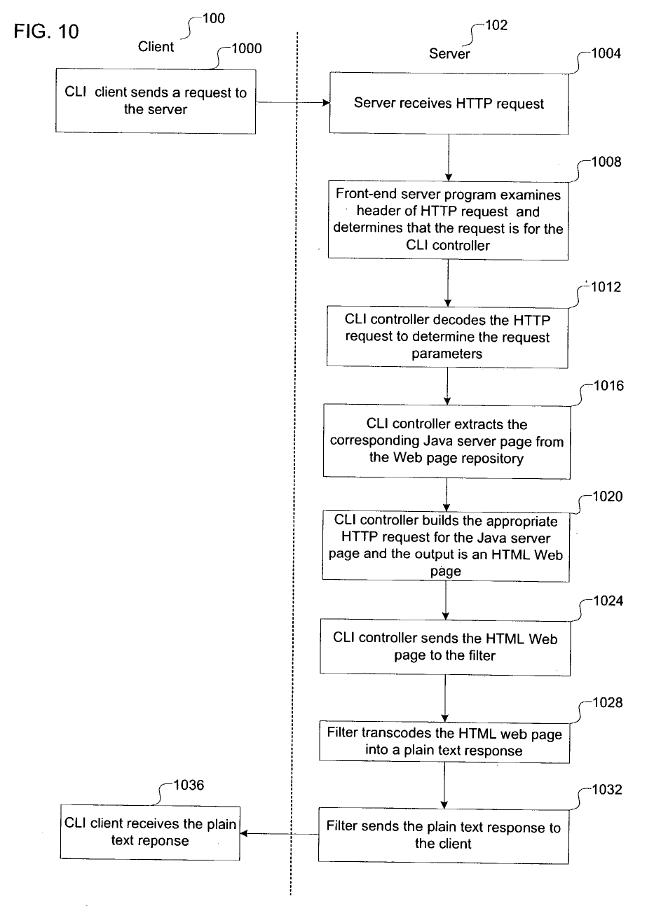

FIG. 10 illustrates logic for sending data to the command line interface client 108, in accordance with described implementations of the invention. The logic is implemented in the client 100 and the server 102.

Control begins at block 1000 where the command line interface client 108 sends the request 900 to the server 102. The request 900 may include request parameters 700. The request 900 may be structured in a variety of ways, including in an HTTP or HTTPS protocol.

Control proceeds to block 1004 where the server 102 receives the request 900. In certain implementations, the request 900 is received via the HTTP protocol and may include HTTP headers in a format known in the art. The HTTP headers may identify the requesting entity in a user agent header field known in the art. The front end server program 120 may examine the HTTP headers of the request 900 and determine that the request 900 has the CLI client 108 as the requesting entity and direct the request 900 to the CLI controller 110 (at block 1008). Control proceeds to block 1012 where the CLI controller 110 decodes the request to determine the request parameters 700. At block 1016, the CLI controller 110 extracts the Web page 702 that corresponds to the request parameters 700 by referring to the mapping data structure 116. The Web page 702 may be a Java server page in certain implementations.

Control proceeds to block 1020 where the CLI controller 110 builds an appropriate HTTP request for the JSP based Web page 702, and the output is an HTML Web page containing graphical elements when the Web page 702 is a Java server page. The appropriate HTTP request for the JSP based Web page 702 is based on the request 900. At block 1024, The CLI controller sends the HTML Web page containing graphical elements to the filter 112. In certain implementations, the CLI controller 110 may determine the appropriate filter 112 from the deployment descriptor file 118.

Control proceeds to block 1028, where the filter 112 transcodes the Web page 702 containing graphical elements to the plain text page 400. At block 1032, the filter 112 sends the plain text page 400 to the client 108. Control proceeds to block 1036, where the command line interface client 108 receives the plain text page 400 and displays the plain text page 400 to the user.

According to the logic described in FIG. 10, the server 102 responds with the plain text page 400 when the server 102 receives a request from the command line interface client 108. If the server 102 receives a request from the Web browser then the server 102 responds with a Web page that may contain graphical elements.

The implementations provide a way to store Web pages on a server that are rendered intelligibly both on a Web browser and as a plain text on a command line interface. The implementations allow a Web server to send equivalent data to both a Web browser interface and a command line interface, where the data sent to the command line interface excludes the graphical elements sent to the Web browser interface. Therefore, the Web server does not have to store separate sets of pages for the Web browser interface and the command line interface.

The implementations allow a single command line interface client to retrieve data from a plurality of Web pages included in a server. When additional Web pages are included in the server no changes are needed for the command line interface client. Therefore, the implementations allow a thin client implementation of the client 100 to retrieve information from a server by both a command line interface and a Web browser. In a thin client implementation the software resident on the client 100 is relatively small when compared to a fat client implementation. A single command line interface client 108 once written for the client 100 can interface with a variety of servers in heterogeneous environments and as a result the client 100 may be considered to be a thin client. Any code or data changes that need to be made to support different Web pages may be made in the server 102.

Furthermore, in certain implementations if an organization deploys the server 102, a client 100 that does not have the command line interface client 108 can actively download the thin command line interface client from the server 102.

The described techniques may be implemented as a method, an apparatus or an article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium, such as hard disk drives, floppy disks, tape), optical storage (e.g., CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which implementations are made may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the implementations, and that the article of manufacture may comprise any information bearing medium known in the art.

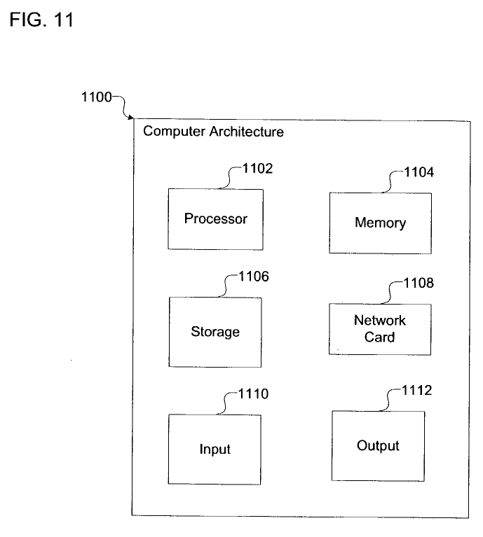

FIG. 11 illustrates a block diagram of a computer architecture in which certain aspects of the invention are implemented. FIG. 11 illustrates one implementation of the client 100 and the server 102. The client 100 and the server 102 may implement a computer architecture 1100 having a processor 1102, a memory 1104 (e.g., a volatile memory device), and storage 1106 (e.g., a non-volatile storage, magnetic disk drives, optical disk drives, tape drives, etc.). The storage 1106 may comprise an internal storage device, an attached storage device or a network accessible storage device. Programs in the storage 1106 may be loaded into the memory 1104 and executed by the processor 1102 in a manner known in the art. The architecture may further include a network card 1108 to enable communication with a network. The architecture may also include at least one input 1110, such as a keyboard, a touchscreen, a pen, voice-activated input, etc., and at least one output 1112, such as a display device, a speaker, a printer, etc..

While FIG. 1 illustrates a single CLI controller 110 and a single filter 112, in alternative implementations a plurality of CLI controllers and filters may be included in the server 102. The logic of FIG. 10 describes specific operations occurring in a particular order. Further, the operations may be performed in parallel as well as sequentially. In alternative implementations, certain of the logic operations may be performed in a different order, modified or removed and still implement implementations of the present invention. Morever, steps may be added to the above described logic and still conform to the implementations. Yet further steps may be performed by a single process or distributed processes. Furthermore, many of the software and hardware components have been described in separate modules for purposes of illustration. Such components may be integrated into a fewer number of components or divided into a larger number of components. Additionally, certain operations described as performed by a specific component may be performed by other components. Furthermore, in certain implementations Java server pages may be passed one or more parameters in a manner known in the art.

The data structures, applications, agents, and components shows in FIGS. 1-9 are shown as having specific types of information. In alternative implementations, the data structures, agents, and components may be structured differently and have fewer, more or different fields, components or functions than shown in the figures.

Therefore, the foregoing description of the implementations has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

What is claimed is:

1. A method for interfacing with a command line interface comprising:
determining a page of a first type corresponding to a request received from a command line interface client;
filtering the page of the first type into a page of a second type; and
sending the page of the second type to the command line interface client.

2. The method of claim 1, wherein the request is an HTTP request, and further comprising:
processing a header of the HTTP request to determine that the request is for a controller program for processing command line interface client requests;
decoding the HTTP request to determine request parameters; and
determining the page of the first type corresponding the request parameters.

3. The method of claim 1, wherein the request is received at a server, wherein the server includes a controller program for processing command line interface client requests, and wherein the determining further comprises:
communicating with a page repository that is capable of storing static or dynamic pages; and
receiving the page of the first type from the page repository.

4. The method of claim 1, wherein the page of the first type is a Web page, wherein the page of the second type is a plain text response, and wherein the filtering is performed by a filter program that transcodes the Web page into the plain text response.

5. The method of claim 1, wherein a server program determines the page of the first type corresponding to the request, and wherein a single server program can handle multiple requests from the command line interface client.

6. The method of claim 1, wherein the request comprises a request parameter, the method further comprising:
mapping the request parameter to the page of the first type from information included in a mapping data structure.

7. The method of claim 1, wherein a deployment descriptor file comprises a name of a filter, the method further comprising:
retrieving the name of the filter from the deployment descriptor file;
sending the page of the first type to the filter; and
processing the page of the first type at the filter to perform the filtering.

8. The method of claim 7, wherein the deployment descriptor file further comprises a mapping of the filter to a controller program for processing command line interface client requests.

9. A method for interfacing with a client, comprising:
receiving a request for a page from the client;
determining if the request was received from a browser or a command line interface; and
if the request was received from the command line interface, sending a response corresponding to the requested page to the command line interface.

10. The method of claim 9, wherein the response is a plain text response, and further comprising:
if the request was received from the browser, sending the requested page including graphical elements to the browser; and
if the request was received from the command line interface, transcoding the requested page to the plain text response.

11. A method, comprising:
sending a first request from a command line interface program at a client;
sending a second request from a browser at the client, wherein the first and second requests are for a page;
receiving a response in response to the first request, wherein the response excludes all graphical elements in the page; and
receiving the page in response to the second request.

12. The method of claim 11, wherein the response is a plain text response, wherein the command line interface program can send a variety of requests, and wherein the command line interface program is separate from the browser.

13. A system for interfacing with a command line interface comprising:
a page of a first type;
a page of a second type;
means for determining the page of the first type corresponding to a request received from a command line interface client;
means for filtering the page of the first type into the page of the second type; and
means for sending the page of the second type to the command line interface client.

14. The system of claim 13, wherein the request is an HTTP request, and further comprising:
a controller program for processing command line interface client requests;
means for processing a header of the HTTP request to determine that the request is for the controller program;
means for decoding the HTTP request to determine request parameters; and
means for determining the page of the first type corresponding the request parameters.

15. The system of claim 13, further comprising:
a server, wherein the request is received at the server;
a controller program for processing command line interface client requests, wherein the controller program is included in the server; and
a page repository that is capable of storing static or dynamic pages, wherein the means for determining further performs:
communicating with the page repository; and
receiving the page of the first type from the page repository.

16. The system of claim 13, wherein the page of the first type is a Web page, wherein the page of the second type is a plain text response, and wherein the means for filtering is performed by a filter program that transcodes the Web page into the plain text response.

17. The system of claim 13, further comprising a server program, wherein the server program determines the page of the first type corresponding to the request, and wherein a single server program can handle multiple requests from the command line interface client.

18. The system of claim 13, wherein the request comprises a request parameter, the system further comprising:
means for mapping the request parameter to the page of the first type from information included in a mapping data structure.

19. The system of claim 13, further comprising a deployment descriptor file, wherein the deployment descriptor file comprises a name of a filter, the system further comprising:
means for retrieving the name of the filter from the deployment descriptor file;
means for sending the page of the first type to the filter; and
means for processing the page of the first type at the filter to perform the filtering.

20. The system of claim 19, wherein the deployment descriptor file further comprises a mapping of the filter to a controller program for processing command line interface client requests.

21. A system for interfacing with a client, comprising:
means for receiving a request for a page from the client;
means for determining if the request was received from a browser or a command line interface; and
means for sending a response corresponding to the requested page to the command line interface if the request was received from the command line interface.

22. The system of claim 21, wherein the response is a plain text response, and further comprising:
means for sending the requested page including graphical elements to the browser if the request was received from the browser; and
means for transcoding the requested page to the plain text response if the request was received from the command line interface.

23. A system, comprising:
a client;
a command line interface program coupled to the client;
a browser coupled to the client;
means for sending a first request from the command line interface program at the client;
means for sending a second request from the browser at the client, wherein the first and second requests are for a page;
means for receiving a response in response to the first request, wherein the response excludes all graphical elements in the page; and
means for receiving the page in response to the second request.

24. The system of claim 23, wherein the response is a plain text response, wherein the command line interface program can send a variety of requests, and wherein the command line interface program is separate from the browser.

25. An article of manufacture for interfacing with a command line interface, wherein the article of manufacture is capable of causing operations, the operations comprising:
determining a page of a first type corresponding to a request received from a command line interface client;
filtering the page of the first type into a page of a second type; and
sending the page of the second type to the command line interface client.

26. The article of manufacture of claim 25, wherein the request is an HTTP request, and the operations further comprising:
processing a header of the HTTP request to determine that the request is for a controller program for processing command line interface client requests;
decoding the HTTP request to determine request parameters; and
determining the page of the first type corresponding the request parameters.

27. The article of manufacture of claim 25, wherein the request is received at a server, wherein the server includes a controller program for processing command line interface client requests, and wherein the determining further comprises:
communicating with a page repository that is capable of storing static or dynamic pages; and
receiving the page of the first type from the page repository.

28. The article of manufacture of claim 25, wherein the page of the first type is a Web page, wherein the page of the second type is a plain text response, and wherein the filtering is performed by a filter program that transcodes the Web page into the plain text response.

29. The article of manufacture of claim 25, wherein a server program determines the page of the first type corresponding to the request, and wherein a single server program can handle multiple requests from the command line interface client.

30. The article of manufacture of claim 25, wherein the request comprises a request parameter, the operations further comprising:
mapping the request parameter to the page of the first type from information included in a mapping data structure.

31. The article of manufacture of claim 25, wherein a deployment descriptor file comprises a name of a filter, the operations further comprising:
retrieving the name of the filter from the deployment descriptor file;
sending the page of the first type to the filter; and
processing the page of the first type at the filter to perform the filtering.

32. The article of manufacture of claim 31, wherein the deployment descriptor file further comprises a mapping of the filter to a controller program for processing command line interface client requests.

33. An article of manufacture for interfacing with a client, wherein the article of manufacture is capable of causing operations, the operations comprising:
receiving a request for a page from the client;
determining if the request was received from a browser or a command line interface; and
if the request was received from the command line interface, sending a response corresponding to the requested page to the command line interface.

34. The article of manufacture of claim 33, wherein the response is a plain text response, and the operations further comprising:
if the request was received from the browser, sending the requested page including graphical elements to the browser; and
if the request was received from the command line interface, transcoding the requested page to the plain text response.

35. An article of manufacture, wherein the article of manufacture is capable of causing operations, the operations comprising:
sending a first request from a command line interface program at a client;
sending a second request from a browser at the client, wherein the first and second requests are for a page;
receiving a response in response to the first request, wherein the response excludes all graphical elements in the page; and
receiving the page in response to the second request.

36. The article of manufacture of claim 35, wherein the response is a plain text response, wherein the command line interface program can send a variety of requests, and wherein the command line interface program is separate from the browser.
